(19) United States
(12) Patent Application Publication
(10) Pub. No.: US 2002/0010645 A1
(43) Pub. Date: Jan. 24, 2002

(54) Backend commerce engine

(76) Inventors: David Hagen, Southern Pines, NC (US); Thomas J. O'Hanlon, Whispering Pines, NC (US)

Correspondence Address: COATS & BENNETT, PLLC, P O BOX 5, RALEIGH, NC, 27602, US

(21) Appl. No.: 09/873,034

(22) Filed: Jun. 1, 2001

Related U.S. Application Data
(63) Continuation-in-part of application No. 09/680,796, filed on Oct. 6, 2000.
Application No. 09/680,796 is a continuation-in-part of application No. 09/614,399, filed on Jul. 12, 2000.
Application No. 09/680,796 is a continuation-in-part of application No. 09/750,954, filed on Dec. 28, 2000.
Application No. 09/680,796 is a continuation-in-part of application No. 09/842,997, filed on Apr. 26, 2001.

(51) Int. Cl. G06F 17/60

(52) U.S. Cl. 705/26

(57) ABSTRACT

A call center enables sales agents to push content to a potential consumer at a portal to promote a good or service. The sales agents are equipped with software resources that provide information about the consumer to the sales agent to promote up-sell and cross-sell options.

### Related Applications

The present application is a continuation-in-part of U.S. Pat. application Ser. No. 09/680,796, filed Oct. 06, 2000, which is a continuation-in-part of U.S. Pat. Application Ser. No. 09/614,399, filed Jul. 12, 2000. The present application is also a continuation-in-part of U.S. Pat. Application Ser. No. 09/750,954, filed 28 Dec. 28, 2000, as well as a continuation-in-part of U.S. Pat. Application Ser. No. 09/842,997, filed 26 Apr. 26, 2001 entitled Method to Attract Consumers to a Sales Agent. The disclosures of these four applications are incorporated by reference in their entireties as if set forth fully herein.

### BACKGROUND OF THE INVENTION

Field of the Invention

The present invention is directed to a system that enables multiple portals to access a call center for the provision of content to consumers at the multiple portals so that a sale may be consummated.

Description of the Related Art

Downtown department stores stand as hollow shells on many main streets throughout the United States. The customers and businesses have fled to strip malls and outlet complexes. Revitalization plans have come and gone, without much success in many cities.

The relocated businesses are also experiencing difficulty as tight labor markets move trained sales agents from retail environments to other more lucrative lines of work such as information technology. These businesses have also seen slumps in revenue as Internet based businesses have come online and become viable competitors.

Internet companies are likewise experiencing difficulties, having experienced numerous high profile flameouts, such as the recent failure of pets.com. Internet companies are failing from, in part, flawed business plans, poorly designed, non-friendly web page layouts, difficult ordering processes, and a lack of personal interaction. Statistics showed that some sixty to eighty percent of online transactions were not completed in 2000.

GateLinx, Corp., assignee of the present invention, has proposed several methods in the previously incorporated parent applications of improving sales to potential consumers through a number of portals including, among others, a kiosk, a set top box, and an incentive based piece of software installed on a computer. The common theme of the patent applications directed to these inventions is the use of a call center staffed by trained sales agents that may use a variety of techniques to push content to the potential consumer to help complete the sale. The present invention focuses on the backend of these portals and how the potential consumer communicates with the sales agent, regardless of the portal used.

### SUMMARY OF THE INVENTION

The present invention comprises using a call center to enable sales agents to push content to a potential consumer at a portal to promote a good or service. The sales agents are equipped with software resources that provide information about the consumer to the sales agent to promote up-sell and cross-sell options.

A potential consumer approaches a portal, such as a kiosk, computer, or set top box and makes a “call” to a call center. In one embodiment, the potential consumer is connected to a sales agent associated with that call center. Information relating to the potential consumer is concurrently passed to the sales agent and a commerce server. The commerce server then provides information to the sales agent about what sort of up-sell and cross-sell options might be appropriate for this particular potential consumer. The sales agent may then use that information to present a multi-media, interactive sales presentation to the potential consumer in an effort to consummate the sale.

In another embodiment, a potential consumer is concurrently routed to the commerce server and to a third party vendor with whom the call center has a contract. The third party vendor may allow the potential consumer to contact one of their in-house trained sales agents and establish a high bandwidth connection between the potential consumer portal and the sales agent. The call center maintains a record of how long the potential consumer is connected to the third party sales agent. The commerce server may provide the third party sales agent with information comparable to that provided to the other sales agents for the purpose of allowing the sales agent to pick information to send to the potential consumer. After the communication link is terminated, the third party may be billed by the call center based on the amount of time that the connection was made.

### BRIEF DESCRIPTION OF THE DRAWINGS

FIG. 1 illustrates a network of portals connected to a call center of the present invention;

FIG. 2 illustrates a kiosk that may serve as a portal for use in with the network of FIG. 1;

FIG. 3 illustrates a television set top box that may serve as a portal for use with the network of FIG. 1;

FIG. 4 illustrates a computer that may serve as a portal for use with the network of FIG. 1;

FIG. 5 illustrates a functional block diagram of an exemplary embodiment of a sales agent's station;

FIG. 6 illustrates a flow chart diagram of an exemplary embodiment of a method by which the present invention works; and

FIG. 7 illustrates a flow chart diagram of a second embodiment of a method by which the present invention works.

### DETAILED DESCRIPTION OF THE INVENTION

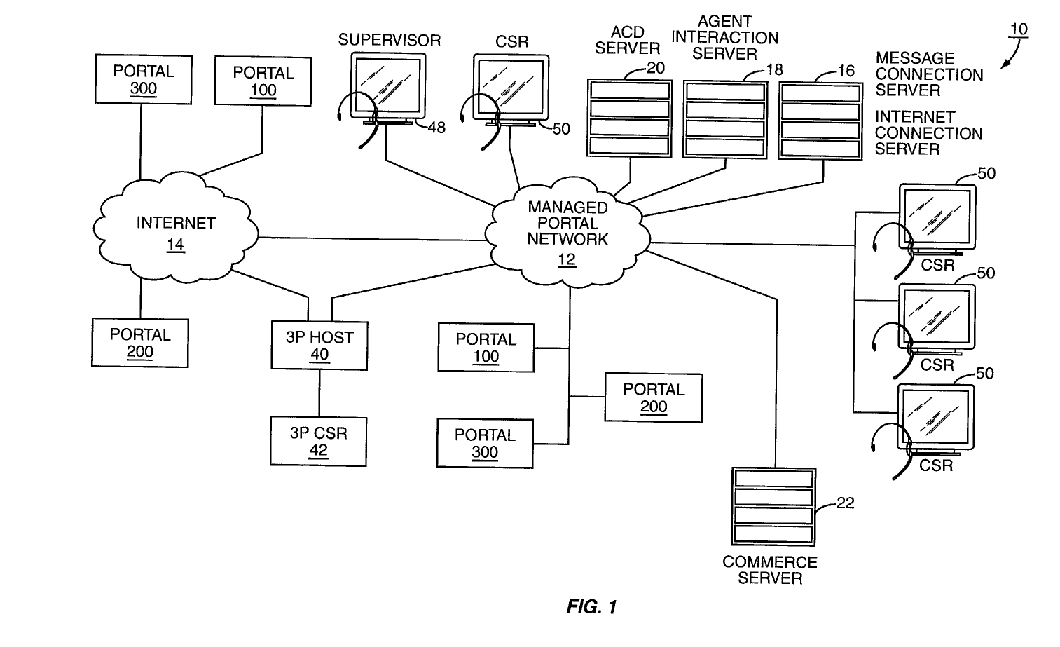

The present invention is directed to a sales technique by which potential consumers are put into contact with visual representations of a remotely positioned sales agent. The sales agent pushes content to the potential consumer to facilitate the sale and also solicits information about the potential consumer to determine possible up-sale and cross-sale opportunities. To this end, a network must be in place to allow the communication between the sales agent and the potential consumer. Such a network is illustrated in FIG. 1, referenced generally by communication system 10. Communication system 10 may include a managed portal network 12 operated by a service provider operating according to the present invention, although this need not be true. Managed portal network 12 interfaces with the Internet 14 and particularly with the World Wide Web (www). A call center is also associated with the managed portal network 12. This call center may be comparable to that disclosed in the parent applications. Alternatively, the call center may be comparable to that disclosed in U.S. Pat. No. 6,046,762, the entire disclosure of which is hereby incorporated by reference. A brief overview of an appropriate system is herein provided to avoid the need to read those references. However, the interested reader is encouraged to read the references for a complete and full understanding of the call center. A message connection server 16, which may double as an Internet connection server, an agent interaction server 18, and an ACD server 20 may also form part of the managed portal network 12. Further, a plurality of customer service representative (CSR) stations 50 and supervisor stations 48 (only one shown) may be included within the managed portal network 12. Still further, a commerce server 22 may be part of the managed portal network 12. It should be appreciated that the communicative links between elements of the managed portal network 12 are high bandwidth, high speed connections such as T1 lines, E1 lines, broadband wireless links, two-way satellite communication, cable lines, fiber optic lines, or the like. However, data compression technology allows normal phone lines or twisted pair lines to be used if required.

The supervisor station 48 may be enabled such that the supervisor attending that station 48 may monitor the CSR stations 50 by listening in on calls placed thereto, keyboard stroke detection, or other conventional supervising techniques. The supervisor stations 48 may be proximate to or remote from the CSR stations 50 as needed or desired.

Managed portal network 12 may further be connected to a third party's server 40 by appropriate communicative links. The third party may be a vendor or other business that wishes to use parts of the services provided by the managed portal network 12 but employ their own sales agents using third party CSR stations 42. CSR stations 42 and 50 will be explained in greater detail below.

Commerce server 22 may be a conventional data processing unit having a microprocessor or other circuit based intelligence with memory units attached thereto. Commerce service 22 serves the purpose of storing multi-media content for later use by the sales agents at CSR stations 50. This multi-media content may include web pages, data files, three dimensional images, graphical images, or the like as needed or desired. It is expected that a service provider who runs the call center will approach vendors and cooperatively create this content. In one embodiment, the service provider may import a product catalog from the vendor (third party host 40) and arrange images, price information, and descriptive text to fit a branded image for the service provider. In addition to the images and web pages, audio files may also be available. Likewise, it is possible that the service provider or vendor may have certain suggested approaches to selling certain goods or services and therefore scripts may be provided for the sales agent. In another embodiment, the vendor may create all of the data, images, and other content in house and merely provide copies of this information to the service provider for storage on the commerce server 22.

Commerce server 22 may additionally act to facilitate interaction with a courier service such as UPS, FEDERAL EXPRESS, or the like. In addition to that function, the commerce server 22 may be designed handle accounting functions such as processing credit card orders, receiving bank account information, or other financial and/or accounting services if needed or desired.

A plurality of portals 100, 200, 300 may be connected directly to the managed portal network 12, indirectly through the Internet 14, such as through an Internet Service Provider (ISP) such as Time Warner's Roadrunner service, aol.com, Bellsouth.net, or through some other medium. Portal 100 may be a network kiosk 100. Portal 200 may be a computer loaded with the appropriate software. Portal 300 may be a set top box operating in conjunction with a television. Each portal will be explained in greater detail below. Note that these portals 100, 200, 300 are intended to be exemplary and nonlimiting. Servers 16, 18, and 20 act to route messages from portals 100, 200, 300 to CSR stations 42, 50 and to the commerce server 22 as needed and as explained in greater detail below.

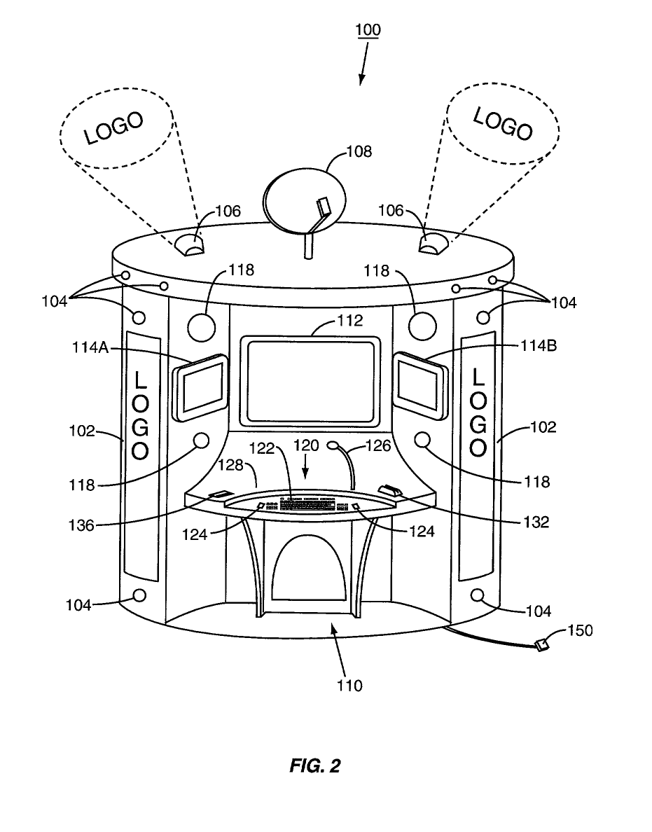

The portals 100, 200, 300 of the present invention are set forth with reference to FIGS. 2-4. These portals 100, 200, 300 are designed to help potential consumers contact the sales agents so that a sale may be promoted, customer service secured, or other communication take place as needed or desired.

Portal 100 may comprise a network kiosk 100 as illustrated in FIG. 2. Network kiosk 100 may include surface indicia 102 such as company logos, banners, promotional phrases or the like. Further, to promote the eye candy feel of the network kiosk 100, lights 104 may be positioned strategically throughout the network kiosk 100. Further, top lights 106 may also be incorporated into the network kiosk 100. Top lights 106 may be spotlights with indicia displayed thereon (not shown), lasers, or the like, as needed or desired. Still further, a mock up of the product 108 sold through the network kiosk 100 may also be positioned on the top of the network kiosk 100. For example, if the network kiosk 100 were designed to promote DIRECTV and its associated satellites, then the surface indicia 102 may state DIRECTV and the logos shown in the lights 106 may state the same. Further, the product 108 may be a real satellite dish or mock up of a satellite dish. Other arrangements are also possible, however, the overarching concept behind the network kiosk 100 is to attract the eye and draw customers to the network kiosk 100. Thus, any ornamentation should preferably be designed to do such. For example, a scrolling text bar (not shown) could surround the top of the network kiosk 100.

While the dimensions of the network kiosk 100 are not material to the present invention, an exemplary embodiment has a height of approximately seven feet tall and a diameter of approximately ten feet. While the network kiosk 100 as shown is round, other shapes and sizes are also within the scope of the present invention.

Multiple customer interaction stations 110 (only one shown) may be included in a network kiosk 100. Each customer interaction station 110 may include a primary display 112, which in an exemplary embodiment is a computer monitor. Alternatively, a flat, high definition, television screen such as that sold by PHILIPS, SONY, or the like may be used. Supplemental side displays 114A and 114B may also be positioned, one on either side of the primary display 112. A top display (not shown) may be positioned above the primary display 112 or on the ceiling of the customer interaction station 110. Speakers 118 may further be positioned advantageously about the customer interaction station 110. In an exemplary embodiment, full stereo sound capabilities are available in the customer interaction station 110. Other output devices may also be provided as needed or desired to convey information to customers. For example, tactile boards for the visually impaired or other devices may be incorporated into the customer interaction station 110.

As the purpose of the customer interaction station 110 is customer interaction, each customer interaction station 110 may include customer inputs 120 as well. In particular, a keyboard 122, a mouse 124, and microphone 126 may be provided on a table-like area 128. While a mouse 124 is particularly contemplated, equivalently, a joystick, a roller ball, an electronic writing pad, a touchpad, or the like may be substituted or provided in addition thereto. Such customer inputs 120 may be provided on both the left and right hand sides of the keyboard 122 to accommodate left and right-handed users. Further, the arrangement of customer inputs 120 may preferably be arranged so as to provide an ergonomic environment.

Each customer interaction station 110 may further include customer payment devices 130, which may include a check reader/acceptor 132, a magnetic card reader 134, a cash acceptor 136, or the like as needed or desired. The magnetic card reader 134 may be a swipe type device or an insert type device, such as are commonly found on Automated Teller Machines (ATMs). Alternatively, a wireless payment device may be used. Such a wireless payment device is commonly seen on heavily traveled toll roads and comprises an interrogator in the customer interaction station 110 and a transponder with account information thereon in possession of the customer. As such devices are conventional, further discussion thereof will be omitted.

A high bandwidth communications link 150 is also included in the portal 100. Since each high definition video signal presently requires approximately 180 MHz, it should be appreciated that each customer interaction station 110 may require approximately 1 GHz of bandwidth to provide adequate reception of incoming signals and transmission of outgoing signals. The high bandwidth communications link 150, while shown as a wirebased link, may alternatively be a wireless communications link and instead of a wire and plug (as shown), an antenna may equivalently be provided. Further, wire, in this context, should be interpreted as including fiber optic solutions.

While not shown, it is possible that each customer interaction station 110 may include a controller, such as a microprocessor or other local device that acts as a local intelligence for the customer interaction station 110. Such a controller may include communications software and/or hardware to control the communications link 150. Alternatively, a single controller may be provided for the entire portal 100. As another alternative, each customer interaction station 110 may be a “dumb” terminal, with all functions controlled from a remote location.

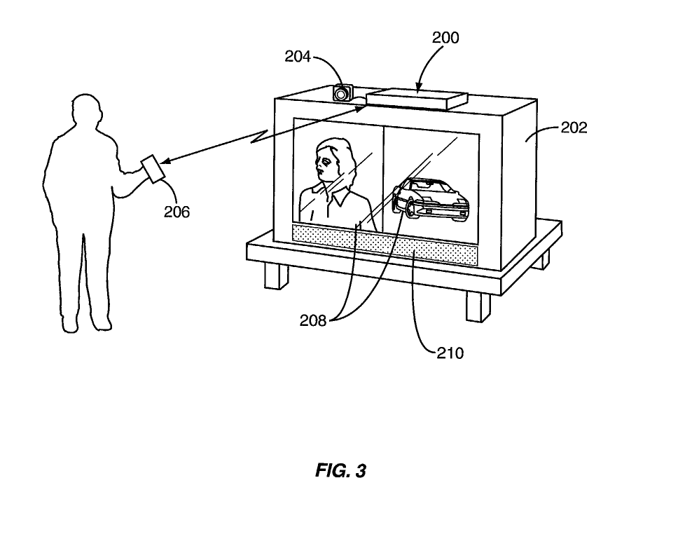

Portal 200 comprises a set top box, and is illustrated in FIG. 3. Set top box 200 is illustrated positioned atop a television 202 for viewing by a consumer in the comfort of their home.

The consumer may be equipped with a remote control device 206 that wirelessly communicates with the set top box 200 and/or the television 202. Television 202 may be capable of operating with split screens 208 and have speakers 210. As an alternative to split screens 208, comparable technology such as picture-in-a-picture, overlay, or the like, may be substituted.

Set top box 200 may comprise a central processing unit such as an INTEL PENTIUM II, AMD K6, or the like microprocessor (or better) with associated motherboard. Potentially positioned on the same motherboard would be memory that may be any appropriate memory such as RAM, ROM, or the like. Set top box 200 may further comprise a microphone, a camera 204, a satellite receiver, and a remote control unit receiver. Optionally, set top box 200 may still further comprise a television receiver, a cable receiver, a DVD player, a CD player, and a VHS player. It should be appreciated that some of these units may be modularized and in separate boxes, but for the purposes of the present invention, such a modular set of stackable components also falls within the definition of set top box 200.

Further, software (not shown explicitly) may be stored in the memory of the set top box 200. The software may act to control the communication between the various components as well as run some of the functionality of the present invention.

Alternatively, dedicated ASICs or other hardware may be created that are hardwired to perform the same functions. While not shown, it should be appreciated that the receivers mentioned above have the appropriate antennas when needed.

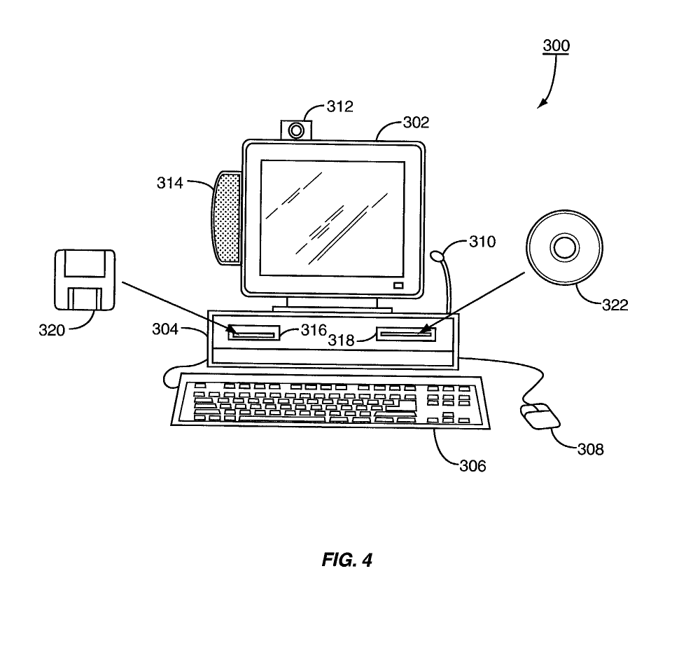

Portal 300 may comprise a personal computer or other similar data processing device, and is illustrated in FIG. 4. Computer 300 may comprise a display 302, a desk unit 304 housing a motherboard and microcontroller such as an INTEL PENTIUM IV or the like, a keyboard 306, a mouse 308, a microphone 310, a camera 312, a speaker 314, and other paraphernalia as is well understood. Further, the desk unit 304 may comprise a floppy disc drive 316 and a CD-drive 318 capable of receiving computer readable media such as a disk 320 and a CD 322 respectively. The relevant portions of the software of the present invention may be stored on the computer readable media 320, 322 as needed or desired. Note that the software may alternatively be preinstalled on the hard drive of the desk unit 304 or may be downloaded from a remote source such as the Internet 14.

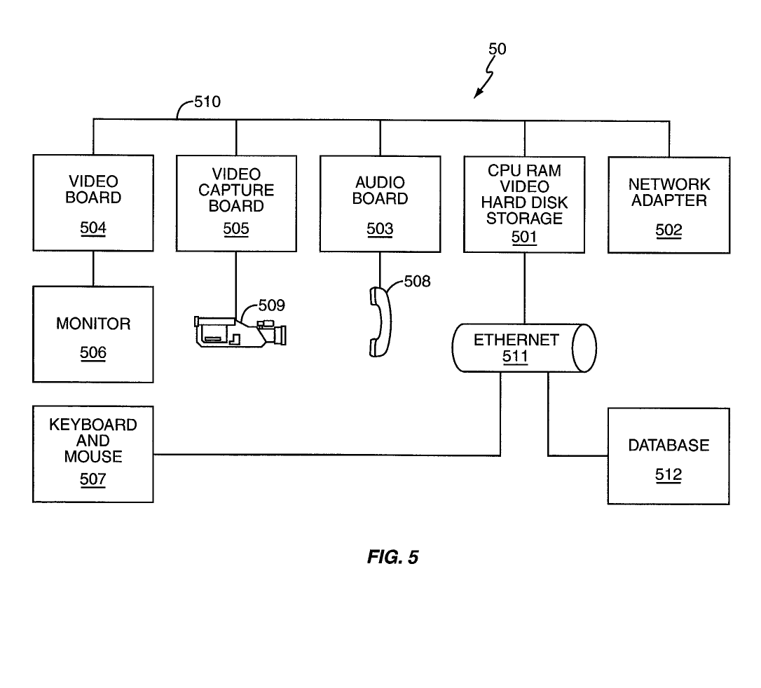

Sales agents are well equipped to handle incoming calls from any of these portals 100, 200, 300. CSR station 50 is illustrated in FIG. 5, with the understanding that the CSR station 42 is substantially identical. CSR station 50 is based on a standard IBM compatible Pentium or other comparable computer 501. Standard parts of the computer 501 are the CPU, memory, a video card, and a hard drive. Computer 501 may operate on WINDOWS or some other comparable operating system.

The CPU communicates via bus 510 with network adapter 502 such as the INTEL ETHEREXPRESS 16TP. Network adapter 502 connects to an Ethernet backbone 511, which carries all administration data as well as relevant multimedia information.

Voice traffic is sent to audio-board 503 (such as the ACER S23) which connects to the telephone headset (or speaker and microphone) 508. The audio-board translates the digitized audio to an analog signal utilizing industry standard codecs such as MICROSOFT PCM, ADPCM, or Group Special Mobile (GSM) compression algorithm set by the European Telecommunication Standards Institute, which are then played via the speaker of the headset 508. Similarly, analog audio generated by the microphone of the headset 508 is converted by the audio-board to a digital format utilizing, for example, the above-mentioned codecs. The resulting digital signal is packetized by computer 501 and forwarded to network adapter 502 to be sent to a caller. As an option, the outgoing signal can be modified by digital signal processing means utilizing voice morphing techniques to modify an agent's voice.

Video traffic is routed to video capture board 505, such as Creative Labs Video Blaster SE 100, where the data is decoded utilizing industry standard codecs such as Crystal Net SFM Codec (32) or NSVIDEO™ V2.1 Gray 8-bit included with a package such as CONNECTIX VIDEOPHONE for display on monitor 506. Similarly, video arriving from camera 509 is encoded, for example, by the above-mentioned codecs. Video data can consist of information such as caller and/or agent images or images of objects of interest that the caller and/or agent put in front of the camera 509 or other camera. As an option, the outgoing video signal can be modified by digital signal processing means utilizing image morphing techniques to modify an agent's image.

As a further option, the video image of the sales agent may be modified to be a “genie” such as that provided by LIPSInc. of Research Triangle Park, N.C. Details of this “genie” technology may be located at www.lipsinc.com. This may be appropriate where a vendor wishes a particular brand image associate with a product or service. For example, DISNEY may wish to have a talking head of MICKEY MOUSE interact with the potential consumer rather than a normal human. This may also be done for less altruistic reasons such as to cover up the appearance of a sales agent who, while technically competent, would not appeal to a target audience group. Of course, other reasons for using such a genie are also contemplated and fall within the scope of the present invention.

In addition to the video signal of the camera 509, it is expected that the sales agent may use images from the commerce server 22 or other source to push content to the potential consumer. The call center specifically allows the sales agent to co-op the portal 100, 200, 300 in such a fashion that the sales agent may control images displayed at the portal, 100, 200, 300. In this manner, a web page may be displayed and links there from actuated so that the potential consumer may receive more content to help complete the sale.

Standard video monitor 506, such as SAMSUNG SYNCMASTER 17GLS, is used to display information about callers, wait queues, and database information related to the respective service to be provided by the agent to the caller. If the call is made from the appropriate portal 100, 200, 300, the agent can view the caller's displays. In the event a call is made from a portal 100, 200, 300 equipped with a camera, the agent can view the caller's image. All the information above appears in separate windows, which can be arranged by the agent according to her preferences. Keyboard and mouse 507, such as standard MICROSOFT keyboards and mice, are used as input devices.

Ethernet backbone 511 connects the CSR station 50 to a database 512 that may be located conceptually on ACD server 20, or commerce server 22 but may be located on any accessible memory device. Database 512 may be a living database in that every sales agent may enter information elicited during a sales opportunity. The types of information are essentially limitless, but are preferably of the sort that improve sales opportunities. This may include demographics, e.g., seventy-two percent of the callers are male and twenty-four percent are between eighteen and twenty-five. This may also include information about what sort of products in which the potential consumer was initially interested, what sort of products the potential consumer also considered, potential upsales or cross-sales based on a given product, and the like. For sales opportunities where there is a bi-directional video connection, the sales agent may also enter information about the appearance of the potential consumer, as well as environmental data. E.g., the person has a dog, a female roommate, a big leather couch, and wears TOMMY HILFIGER clothes. At a minimum, the sales agent may enter caller identification information. E.g., potential consumer Mr. Smith called from (919) 555-1111, 133 Anywhere Street, Erehwon, N.C., 27602. This may be mined, compiled, manipulated and updated to detect new trends in the marketplace, consumer buying habits, and the like, as well understood in the advertising industry. In addition to entering this information, the sales agents may also draw upon this information in database 512 to present up-sales and cross-sale opportunities to potential consumers. E.g., “While you are interested in this $200 digital camera, this $450 digital camera offers the following additional features, might you be interested in the second?” or “This television set looks wonderful with this DVD player, which we sell for only an additional $100, might you be interested in that as well today?” The more information in the database, the better informed the sales agent is about what sort alternate sales opportunities may exist. Note that this is different from a script that many call centers use, in that the database 512 evolves over time to reflect the changing trends in the marketplace and does not force a potential consumer down a particular path. Note that the database 512 may be programmed to make estimates of desirable alternate sales opportunities, but could merely present the statistics and let the sales agent make the determination about what sort of alternate sales to present to the potential consumer.

Note that this database is also accessible from third party CSR stations 42, and may be used by those sales agents in the same fashion as described above.

(Are we missing anything here?)

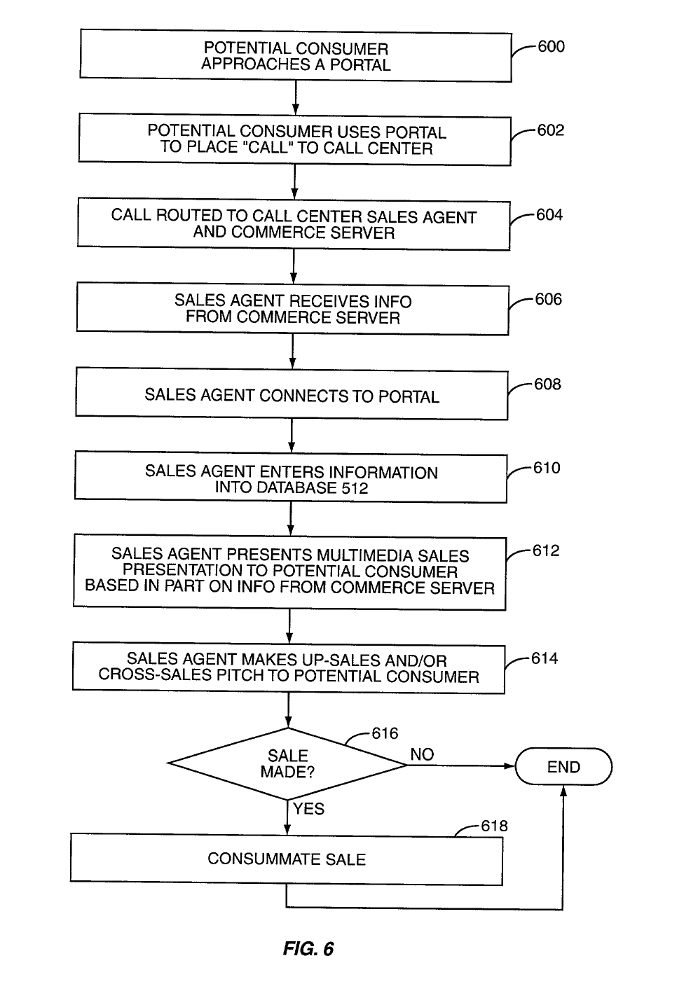

Against this backdrop, the methodology of the present invention may be explored. In particular, FIG. 6 illustrates a first embodiment of a method of using the present invention. A potential consumer approaches a portal 100, 200, 300 (block 600). This may be, for example, approaching a kiosk 100 in a mall, approaching their television set top box 200, approaching their home computer 300, or other portal as needed or desired. This approach may be done with a particular potential purchase in mind, a fact-finding mission in mind, a customer service inquiry, or the like. The potential consumer uses the portal 100, 200, 300 to place a “call” to the call center (block 602). As discussed in the incorporated U.S. Pat. No. 6,046,762 patent, this “call” may be telephonic, computer, or televideo as needed or desired depending on the facilities at the portal 100, 200, 300.

Coupled to the “call” may be information about what sort of product or service the potential consumer has expressed interest, a call source identifier, a portal system capabilities description, and other information that may be available. Based on this information, the call is routed to an appropriate call center agent at a CSR station 50 and to the commerce server 22 simultaneously (block 604). The commerce server 22 provides web pages and other information to the sales agent (block 606). The sales agent then communicatively connects to the portal 100, 200, 300 (block 608).

The sales agent may be presented with an image of the potential consumer from the portal 100, 200, 300, or at a minimum may have the opportunity to ask the potential consumer some questions about themselves. The elicited answers or the observed characteristics may then be input into the database 512 (block 610). This information can be as simple as “male, age 27, name Jim Smith” or as complex as “Jim Smith appears in a living room with a female companion (wife?) and two dogs. The sofa is leather and there is nice artwork on the walls. The place is immaculate and they are wearing Tommy Hilfiger clothes.”

The sales agent then responds to the potential consumer's inquiry. If the inquiry is a customer service call, then the opportunities for sales may be limited. This is not always true because a potentially valid response to such an inquiry would be “We don't support that model anymore, but many of our customers are upgrading the Model X2001, could I tell you about those features” or the like. If the potential consumer called to inquire about a purchase, this transition may be even smoother. The sales agent then presents a multimedia sales presentation (or service response) to the potential consumer based in part on the information received from the commerce server 22 (block 612). This may include pushing web pages or other data files to the consumer for viewing. As the U.S. Pat. No. 6,046,762 patent describes, the sales agent may control the remote display on the portal 100, 200, 300 and control what the potential consumer sees. For those portals without video capabilities, the sales agent may still use the information from the commerce server 22 to promote the sale in the most appropriate manner.

The sales agent has the opportunity to make up-sales and/or cross-sales pitches to the potential consumer as part of the presentation (block 614). For example, “this car comes with air conditioning standard, but can I interest you in any of our sun roofs?”

If the sale is not made (block 616), for whatever reason, the process may end or iterate with respect to a different good or service. If however, the sale is made (block 616), the sales agent then may consummate the sale (block 618). This may include securing payment information from the consumer, checking inventory, arranging shipping, other accounting steps, and the like as needed or desired. Shipping information may be performed by the commerce server 22 contacting a web site of a third party courier such as UPS, FEDERAL EXPRESS, or the like as needed or desired.

Note that the precise order of many of these events need not be linear as illustrated in the flow chart of FIG. 6, or the order may be changed about and still fall within the scope of the present invention. For example, the sales agent may connect to the portal 100, 200, 300 concurrently with or after receiving the information from the commerce server 22.

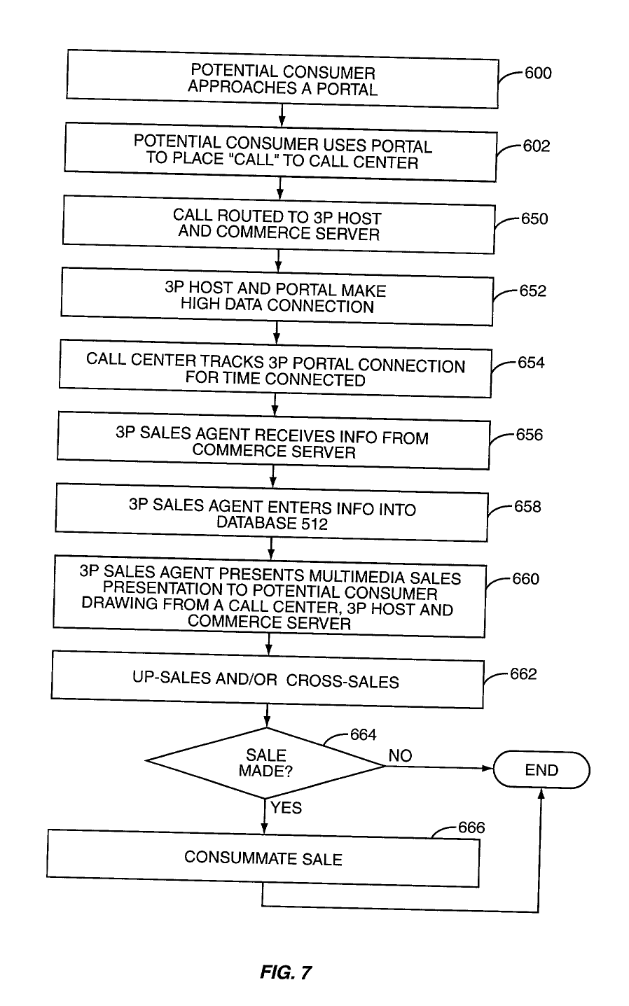

Another embodiment of the present invention is illustrated in FIG. 7. This process is similar to that illustrated with respect to FIG. 6 in that a potential consumer approaches a portal 100, 200, 300 (block 600) and places a “call” to the call center (block 602). In this embodiment, the potential consumer is inquiring about a good or service which the service provider does not directly sell, but rather acts as an intermediary for a third party seller. Thus, while the call does reach the call center, the call is in reality passed to the third party host 40 and the commerce server 22 (block 650). The third party host 40 and the portal 100, 200, 300 then secure a high data rate connection (block 652). This high data rate connection is intended for the conveyance of video signals, although other data may also be transmitted thereacross. In contrast to the previous embodiment, this high data rate connection need not pass through the managed portal network 12 to get to the portal 100, 200, 300, but rather may be a peer-to-peer connection. This eases the load on the managed portal network 12.

The call center, most probably the message connection server 16, tracks the third party host 40 to portal 100, 200, 300 connection for the amount of time connected (block 654). If the call is disrupted, the message connection server 16 may facilitate re-establishment of the call. Likewise, it is not expected that the service provider allow this pass through service out of charity. Rather, it is expected that the third party will pay the service provider based on the time for which there was a connection between the third party host 40 and the portal 100, 200, 300.

A sales agent located at the third party CSR 42 receives information from the commerce server 22, including web pages, data files, and the like as described above (block 656). During the call, the third party sales agent may enter information into the database 512 (block 658). This is done for the reasons explicated above. The third party sales agent presents a multimedia sales presentation to the potential consumer drawing from information at the call center, the third party host 40, the commerce server 22 and the database 512 as needed or desired (block 660).

The third party sales agent presents any up-sell or cross-sell opportunities to the potential consumer as appropriate (block 662). If a sale is not made (block 664), the process may end or iterate as needed or desired. If a sale is made (block 664), the sale may be consummated (block 666). This may include the accounting described above, as well as paying a commission to the service provider. This commission may be justified in that but for the service provider's intervention, no sale may have been made. Other justifications and selling points will readily be apparent to those of ordinary skill in the art.

Again, the precise order of events of the flow chart are exemplary and may be rearranged within reason without departing from the scope of the present invention.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A system for promoting sales, comprising:
a call center comprising a plurality of customer service stations adapted to be staffed by sales representatives;
a database accessible by the sales representatives from the customer service stations, said database comprising information relating to up sale or cross sale opportunities; and
a communication link adapted to support bidirectional multimedia communication between the customer service stations and at least one remote portal such that the sales agents may make multimedia presentation to a potential consumer while accessing the database to recommend up sale or cross sale opportunities.

2. The system of claim 1 wherein said customer service stations comprise third party customer service stations;
said database comprising a service provider database; and
said service provider database tracking communication between the third party customer service station and the potential consumer and charging the third party based on said tracking.

3. The system of claim 1 further comprising a shipping module that interfaces with third party courier services to arrange shipping of products or services sold by the sales agent.

4. The system of claim 1 wherein the sales agent is prompted to enter information about the potential consumer in the database during the communication therebetween.

5. The system of claim 4 wherein the database recommends up sale or cross sale opportunities to the sales agent based in part on the information entered by the sales agent about the potential consumer.

6. The system of claim 1 further comprising a plurality of portals through which the potential consumer may contact the sales agent.

7. The system of claim 6 wherein the sales agent may co-opt the portal and control material presented to the potential consumer therethrough.

8. The system of claim 6 wherein at least one of the plurality of portals comprises a network kiosk.

9. The system of claim 6 wherein at least one of the plurality of portals comprises a set top box and television.

10. The system of claim 6 wherein at least one of the plurality of portals comprises a computer.

11. A method of promoting sales, comprising:
accepting, at a call center, an incoming communication from a portal;
connecting the incoming communication to a commerce server and a sales agent;
allowing the sales agent to direct information from the commerce server to the portal for display to a potential consumer;
providing information from a database regarding up sale or cross sale opportunities to the sales agent; and
communicating over a bi-directional multimedia communication link between the potential consumer and the sales agent.

12. The method of claim 11 wherein accepting, at a call center, an incoming communication from a portal comprises accepting an incoming call from a network kiosk.

13. The method of claim 11 wherein accepting, at a call center, an incoming communication from a portal comprises accepting an incoming call from a television set top box.

14. The method of claim 11 wherein accepting, at a call center, an incoming communication from a portal comprises accepting an incoming call from a computer.

15. The method of claim 11 further comprising accepting information into the database from the sales agent during the communication.

16. The method of claim 15 wherein accepting information into the database from the sales agent during the communication comprises accepting information related to the potential consumer.

17. The method of claim 16 further comprising synthesizing information accepted from the sales agent to update the database.

18. A method of receiving information from a potential consumer, comprising:
allowing the potential consumer to use a portal to contact a remote sales agent;
receiving a request for information from the sales agent about a good or service in which the potential consumer has an interest;
sending multimedia information through the portal from the sales agent about the good or service requested;
receiving supplemental information from the potential consumer; and
entering the supplemental information into a database for later use.

19. The method of claim 18 wherein receiving supplemental information from the potential consumer comprises receiving responses to inquiries directed to the potential consumer by the sales agent.

20. The method of claim 18 wherein receiving supplemental information from the potential consumer comprises the sales agent deriving the supplemental information from a visual representation of the potential consumer.
